(19) United States
(12) Patent Application Publication
(10) Pub. No.: US 2025/0170805 A1
(43) Pub. Date: May 29, 2025

(54) BULK CHEESE BARRIER BAG

(71) Applicant: Sealed Air Corporation (US), Charlotte, NC (US)

(72) Inventor: Andrew Peter Fox, Hamilton (NZ)

(21) Appl. No.: 18/840,656

(22) PCT Filed: Feb. 22, 2023
(86) PCT No.: PCT/US2023/013568

§ 371 Date: Aug. 22, 2024

Related U.S. Application Data
(60) Provisional application No. 63/312,939, filed on Feb. 23, 2022.

(51) Int. Cl. B32B 27/08; B32B 7/02; B32B 27/30; B32B 27/32; B65B 5/06; B65B 7/02; B65B 25/06; B65D 30/08; C08L 23/0807; C08L 23/0861

(52) U.S. Cl. CPC B32B 27/08; B32B 7/02; B32B 27/306; B32B 27/32; B65B 5/067; B65B 7/02; B65B 25/068; B65D 31/02; C08L 23/0815; C08L 23/0861; B32B 2250/24; B32B 2307/30; B32B 2307/31; B32B 2307/414; B32B 2307/54; B32B 2307/558; B32B 2307/5825; B32B 2307/7244; B32B 2307/7376; B32B 2307/746; B32B 2439/06; B32B 2439/70; C08L 2203/16

(57) ABSTRACT

A multilayer film and a pouch made therefrom is disclosed. The film having an ethylene-vinyl alcohol copolymer-based barrier layer and an outer layer made from at least 95 wt % of a branched ethylene copolymer. The branched ethylene copolymer being 50 mol % or more ethylene, 50 mol % or less of a C6 to C8 alpha-olefin comonomer, and at least 0.001 mol % of a remnant of a metal hydrocarbyl chain transfer agent. The film including substrate layers between the barrier layer and each outer layer. The film having low oxygen transmission rate and a low a moisture transmission rate.

### CROSS REFERENCE TO RELATED APPLICATION

The present application claims the benefit of U.S. Provisional Patent Application Ser. No. 63/312,939, filed on Feb. 22, 2022, and entitled “BULK CHEESE BARRIER BAG.” The entire contents of which application are incorporated herein by reference.

### BACKGROUND

The subject matter disclosed herein relates to a barrier bag. More particularly, to a barrier bag for packaging bulk cheese.

Current bulk cheese bags are used to package large blocks of cheese. For example, 20 kg blocks of cheese. A gusseted bag is used that is designed to withstand extreme stretch to accommodate the forces required to package large blocks of cheese.

The cheese bags require high strength and abuse resistance to avoid being torn or ripped during the packaging process. In addition, the bag should be stretchable to allow for introduction of the cheese block into the bag.

To package the cheese block into a bag, machines such as Model CL-20 bag loaders available from Cryovac, LLC are used. Automated CL-20 bag loader systems accept large blocks of cheese and packages them automatically into premade gusseted bags. Bags are typically up to 65 cm wide and 48.5 cm long. Four spreader arms open the bag to allow the block of cheese to be inserted into the bag. The bag must be abuse resistant to prevent tearing down the gusset folds at the mouth of the bag during the opening sequence of the spreader arms.

To make the bags abuse resistant polyamide layer(s) such as nylon are included in the bag during the co-extrusion forming process. The addition of nylon layers provides structural strength to the bag. Polyethylene layers are used to provide moisture barrier and seal ability. Oxygen barrier layers such as EVOH are also employed in the bag.

Prior to use, films containing nylon layers must be rehydrated and conditioned prior to use. The process taking about 2 to 4 days which slows the process time from formation of the bag to packaging.

Additionally, this mixture of resins used to make the bag precludes the bag from being mechanically recycled. The nylon has an extremely high melting point whilst polyethylene does not. Therefore, melting the film does not create a reusable resin due to the incompatibility between the nylon and polyethylene. While adding compatibilizer resins can help facilitate recycling, the prohibitive costs invariably preclude this approach. Thus, the film is inevitably consigned to the landfill.

Thus, there is a need for a barrier bag that does not require rehydration, and which has sufficient abuse resistance.

The discussion above is merely provided for general background information and is not intended to be used as an aid in determining the scope of the claimed subject matter.

### BRIEF DESCRIPTION

A multilayer film and a pouch made therefrom is disclosed. The film having an ethylene-vinyl alcohol copolymer-based barrier layer and an outer layer made from at least 95 wt % of a branched ethylene copolymer. The branched ethylene copolymer being 50 mol % or more ethylene, 50 mol % or less of a C₆ to C₈ alpha-olefin comonomer, and at least 0.001 mol % of a remnant of a metal hydrocarbyl chain transfer agent. The film including substrate layers between the barrier layer and each outer layer. The film having a low oxygen transmission rate and a low a moisture transmission rate.

An advantage that may be realized in the practice of some disclosed embodiments of the multilayer barrier bag is good tear resistance, and elongation which allows the pouch to open wider to accommodate a cheese block and still safely return to originally size as the point of plastic deformation has not been reached.

A further advantage according to some embodiments is that there is no need to hydrate/cure the film to restore nylon abuse attributes which eliminates up to 4 days processing time.

Yet, a further advantage according to some embodiments the multilayer barrier bag can enter the polyethylene waste/recycling stream diverting the waste from landfill.

With this new formulation we find that combined with the improved tear resistance, the greater elongation allows the pouch to open wider to accommodate the cheese block and still safely return to originally size as the point of plastic deformation has not been reached.

In one exemplary embodiment, a multilayer barrier film is disclosed. The multilayer barrier film comprises a barrier layer having at least 95 wt % of an ethylene-vinyl alcohol copolymer, based on the total weight of the barrier layer. The film further having a first outer layer comprising at least 95 wt % of a branched ethylene copolymer based on the total weight of the first outer layer, the branched ethylene copolymer comprising 50 mol % or more ethylene, 50 mol % or less of a C₆ to C₈ alpha-olefin comonomer, and at least 0.001 mol % of a remnant of a metal hydrocarbyl chain transfer agent, the branched ethylene copolymer having a density in the range of from 0.910 to 0.930 grams per cubic centimeter. The film has a second outer layer comprising at least 95 wt % linear low density polyethylene, based on the total weight of the second outer layer. The film has a first substrate layer disposed between the barrier layer and the first outer layer. The film has a second substrate layer disposed between the barrier layer and the second outer layer. The multilayer film has an oxygen transmission rate of less than any of 50, 40, 30, 20, 10 or 5 cc at standard temperature and pressure (STP)/m²/day/1 atm measured in accordance with ASTM D3985 measured at 23° C., 75% relative humidity and a moisture transmission rate of less than any of 25, 20, 15, 10 or 5 at standard temperature and pressure (STP)/m²/day measured in accordance with ASTM F1249 measured at 38° C. and 90% relative humidity.

In another exemplary embodiment, a gusseted pouch is disclosed. The gusseted pouch comprises at least one seam and at least two fold lines to create a pair of side gussets in the pouch, the pouch being in a generally cuboidal shape. The gusseted pouch made from a multilayer barrier film comprising a barrier layer having at least 95 wot % of an ethylene-vinyl alcohol copolymer, based on the total weight of the barrier layer. The film further having a first outer layer comprising at least 95 wt % of a branched ethylene copolymer based on the total weight of the first outer layer, the branched ethylene copolymer comprising 50 mol % or more ethylene, 50 mol % or less of a C₆ to C₈ alpha-olefin comonomer, and at least 0.001 mol % of a remnant of a metal hydrocarbyl chain transfer agent, the branched ethylene copolymer having a density in the range of from 0.910 to 0.930 grams per cubic centimeter. The film has a second outer layer comprising at least 95 wt % linear low density polyethylene, based on the total weight of the second outer layer. The film has a first substrate layer disposed between the barrier layer and the first outer layer. The film has a second substrate layer disposed between the barrier layer and the second outer layer. The multilayer film has an oxygen transmission rate of less than any of 50, 40, 30, 20, 10 or 5 cc at standard temperature and pressure (STP)/m²/day/1 atm measured in accordance with ASTM D3985 measured at 23° C., 75% relative humidity and a moisture transmission rate of less than any of 25, 20, 15, 10 or 5 at standard temperature and pressure (STP)/m²/day measured in accordance with ASTM F1249 measured at 38° C. and 90% relative humidity.

In another exemplary embodiment, a method of bagging a food product is disclosed. The method comprises the steps of providing a gusseted pouch; filing the pouch with a solid food product; and sealing the pouch. The gusseted pouch made from a multilayer barrier film comprising a barrier layer having at least 95 wt % of an ethylene-vinyl alcohol copolymer, based on the total weight of the barrier layer. The film further having a first outer layer comprising at least 95 wt % of a branched ethylene copolymer based on the total weight of the first outer layer, the branched ethylene copolymer comprising 50 mol % or more ethylene, 50 mol % or less of a C₆ to C₈ alpha-olefin comonomer, and at least 0.001 mol % of a remnant of a metal hydrocarbyl chain transfer agent, the branched ethylene copolymer having a density in the range of from 0.910 to 0.930 grams per cubic centimeter. The film has a second outer layer comprising at least 95 wt % linear low density polyethylene, based on the total weight of the second outer layer. The film has a first substrate layer disposed between the barrier layer and the first outer layer. The film has a second substrate layer disposed between the barrier layer and the second outer layer. The multilayer film has an oxygen transmission rate of less than any of 50, 40, 30, 20, 10 or 5 cc at standard temperature and pressure (STP)/m²/day/1 atm measured in accordance with ASTM D3985 measured at 23° C., 75% relative humidity and a moisture transmission rate of less than any of 25, 20, 15, 10 or 5 at standard temperature and pressure (STP)/m²/day measured in accordance with ASTM F1249 measured at 38° C. and 90% relative humidity.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is an exemplary cross section of a multilayer barrier bag according to some embodiments;

FIG. 2 is an exemplary isometric view of a gusted pouch according to some embodiments; and

FIG. 3 is an exemplary isometric view of a gusted pouch according to some embodiments.

### DETAILED DESCRIPTION

As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 9 mils, or from 1.1 to 8 mils, or from 1.2 to 7 mils, or from 1.3 to 6 mils, or from 1.5 to 5 mils, or from 1.6 to 4.5 mils, or from 1.8 to 4 mils, or from 2 to 4 mils.

The multi-layer films described herein may comprise at least, and/or at most, any of the following numbers of layers: 2, 3, 4, 5, 6, 7, 8, 9, 10, 11, 12, 13, 14 and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application. In an embodiment, the multilayer film utilizes microlayers. A microlayer section may include between 10 and 1,000 microlayers in each microlayer section.

The multi-layer films described herein includes layers to provide abuse resistance to the film structure. The films further include at least one barrier layer to restrict fluids (such as oxygen) from permeating through the film. The films may further include additional layers, for example to add bulk, provide functionality, abuse resistance, moisture barrier, printing capability or to act as a tie layer.”)

Below are some examples of combinations in which the alphabetical symbols designate the film layers. Where the multilayer film representation below includes the same letter more than once, each occurrence of the letter may represent the same composition or a different composition within the class that performs a similar function.
A/B/A, A/B/D, A/B/D/A, A/C/B/D, A/B/C/D, A/C/B/A, A/B/C/A, A/C/B/C/A, A/D/B/C/A, A/C/D/B/C/A, A/C/D/B/D/C/A, A/C/B/D/B/C/A, A/C/B/D/B/D, A/C/D/C/B/C/D/C/A, and A/C/D/C/B/C/D
“A” represents a heat seal layer, as discussed herein.
“B” represents a barrier layer, as discussed herein.
“C” represents an intermediate layer (e.g., a tie layer), as discussed herein.
“D” represents one or more other layers of the film, such as a substrate layer.

All compositional percentages used herein are presented on a “by weight” basis, unless designated otherwise.

As used herein, the term “seal” refers to any seal of a first portion (i.e., region) of a film surface to a second portion of a film surface, wherein the seal is formed by heating the portions to at least their respective seal initiation temperatures. The sealing can be performed in any one or more of a wide variety of manners, such as using a heated bar, hot air, hot wire, infrared radiation, ultrasonic sealing, radio frequency sealing, impulse sealing, seal bar, seal dome, etc.

### Heat Seal Layer

As used herein, the phrases “seal layer”, “sealing layer”, “heat seal layer”, and “sealant layer”, refer to an outer layer, or layers, involved in the sealing of the film to itself, another layer of the same or another film, and/or another article which is not a film. As used herein, the phrase “skin layer” refers to a film layer having only one of its surfaces directly adhered to another layer of the film and its other surface is exposed to the environment. The primary function of the skin layer is to provide puncture, abuse, thermal and abrasion resistance.

As used herein, the term “heat-seal,” and the phrase “heat-sealing,” refer to any seal of a first region of a film surface to a second region of a film surface, wherein the seal is formed by heating the regions to at least their respective seal initiation temperatures. Heat-sealing is the process of joining two or more thermoplastic films or sheets by heating areas in contact with each other to the temperature at which fusion occurs, usually aided by pressure. The heating can be performed by any one or more of a wide variety of manners, such as using a heated bar, hot wire, hot air, infrared radiation, ultraviolet radiation, electron beam, ultrasonic, and melt-bead. A heat seal is usually a relatively narrow seal (e.g., 0.02 inch to 1 inch wide) across a film. One particular heat sealing means is a heat seal made using an impulse sealer, which uses a combination of heat and pressure to form the seal, with the heating means providing a brief pulse of heat while pressure is being applied to the film by a seal bar or seal wire, followed by rapid cooling of the bar or wire. In general, sealant layers employed in the packaging art have included thermoplastic polymers, such as polyolefin, polyamide, polyester, and polyvinyl chloride.

In an embodiment, the heat seal layer comprises a polymer having a melting point of from 30° C. to 150° C., in another embodiment from 60° C. to 125° C., and in yet another embodiment from 70° C. to 120° C. In one embodiment, the linear low density ethylene/alpha-olefin copolymer is a polymer for use in the heat seal layer. In an embodiment, the heat seal layer has a thickness of between 0.01-0.50 mils. In an embodiment, the heat seal layer has a thickness of between 0.05-0.10 mils. In an embodiment, the heat seal layer has a thickness of between 0.05-0.10 mils. In an embodiment, the heat seal layer has a thickness of less than 0.01 mils. In an embodiment, one or more polymers in the seal layer has a melt index of from 0.1 to 100 g/10 min, in another embodiment from 0.1 to 50 g/10 min, and in yet another embodiment from 1.0 to 40 g/10 min. In an embodiment, the seal layer has a thickness of from 0.01 to 0.20 mil, in another embodiment from 0.02 to 0.15 mil. and in yet another embodiment from 0.03 to 0.1 mil. The thickness of the heat seal layer as a percentage of the total thickness of the film may be at least about, and/or at most about, any of the following: 1%, 3%, 5%, 7%, 10%, 15%, 20%, 25%, 30%, 35%, 40%, 45% and 50%.

Heat seal layers include thermoplastic polymers such as thermoplastic polyolefins and ionomers. In embodiments, polymers for the sealant layer include homogeneous ethylene/alpha-olefin copolymer, heterogeneous ethylene/alpha-olefin copolymer, ethylene homopolymer, ionomer and ethylene/vinyl acetate copolymer. The heat seal layer comprises at least one linear low density polyethylene which is a branched ethylene copolymer.

In some embodiments, the heat seal layer can comprise a polyolefin, particularly an ethylene/alpha-olefin copolymer. For example, a polyolefin having a density of from 0.88 g/cc to 0.917 g/cc, or from 0.90 g/cc to 0.917 g/cc, or from 0.910 g/cc to 0.930 g/cc or less than 0.92 g/cc. More particularly, the seal layer can comprise at least one member selected from the group consisting of high density polyethylene, linear low density polyethylene, medium density polyethylene, low density polyethylene, very low density polyethylene, homogeneous ethylene/alpha-olefin copolymer, and polypropylene. “Polymer” herein refers to homopolymer, copolymer, terpolymer, etc. “Copolymer” herein includes copolymer, terpolymer, etc.

As used herein, the term “copolymer” refers to polymers formed by the polymerization of reaction of at least two different monomers. For example, the term “copolymer” includes the co-polymerization reaction product of ethylene and an -olefin, such as 1-octene. The term “copolymer” is also inclusive of, for example, the co-polymerization of a mixture of ethylene, propylene, 1-propene, 1-butene, 1-hexene, and 1-octene. As used herein, a copolymer identified in terms of a plurality of monomers, e.g., “propylene/ethylene copolymer,” refers to a copolymer in which either a monomer may copolymerize in a higher weight or molar percent than the other monomer or monomers. However, the first listed monomer generally polymerizes in a higher weight percent than the second listed monomer.

As used herein, the phrase “heterogeneous polymer” refers to polymerization reaction products of relatively wide variation in molecular weight and relatively wide variation in composition distribution, i.e., typical polymers prepared, for example, using conventional Ziegler-Natta catalysts. Heterogeneous copolymers typically contain a relatively wide variety of chain lengths and comonomer percentages. Heterogeneous copolymers have a molecular weight distribution (Mw/Mn) of greater than 3.0.

As used herein, the phrase “homogeneous polymer” refers to polymerization reaction products of relatively narrow molecular weight distribution and relatively narrow composition distribution. Homogeneous polymers are useful in various layers of the multilayer heat-shrinkable film. Homogeneous polymers are structurally different from heterogeneous polymers, in that homogeneous polymers exhibit a relatively even sequencing of comonomers within a chain, a mirroring of sequence distribution in all chains, and a similarity of length of all chains, i.e., a narrower molecular weight distribution. Furthermore, homogeneous polymers are typically prepared using metallocene, or other single-site type catalysis, rather than using Ziegler Natta catalysts. Homogeneous polymers have a molecular weight distribution (M_{w}/Mₙ) of less than 3.0 More particularly, homogeneous ethylene/alpha-olefin copolymers may be characterized by one or more methods known to those of skill in the art, such as molecular weight distribution (M_{w}/Mₙ), composition distribution breadth index (CDBI), narrow melting point range, and single melt point behavior. The molecular weight distribution (M_{w}/Mₙ), also known as “polydispersity,” may be determined by gel permeation chromatography. In some embodiments, the homogeneous ethylene/alpha-olefin copolymers have an M_{w}/Mₙ of less than 2.7; in another embodiment from about 1.9 to 2.5; and it yet another embodiment, from about 1.9 to 2.3. The composition distribution breadth index (CDBI) of such homogeneous ethylene/alpha-olefin copolymers will generally be greater than about 70 percent. The CDBI is defined as the weight percent of the copolymer molecules having a comonomer content within 50 percent (i.e., plus or minus 50%) of the median total molar comonomer content. The CDBI of linear polyethylene, which does not contain a comonomer, is defined to be 100%. The Composition Distribution Breadth Index (CDBI) is determined via the technique of Temperature Rising Elution Fractionation (TREF). CDBI determination clearly distinguishes homogeneous copolymers (i.e., narrow composition distribution as assessed by CDBI values generally above 70%) from VLDPEs available commercially which generally have a broad composition distribution as assessed by CDBI values generally less than 55%. TREF data and calculations therefrom for determination of CDBI of a copolymer is readily calculated from data obtained from techniques known in the art, such as, for example, temperature rising elution fractionation as described, for example, in Wild et. al., J. Poly. Sci. Poly. Phvs. Ed., Vol. 20, p. 441 (1982). In some embodiments, homogeneous ethylene/alpha-olefin copolymers have a CDBI greater than about 70%, i.e., a CDBI of from about 70% to 99%. In general, homogeneous ethylene/alpha-olefin copolymers useful in the present invention also exhibit a relatively narrow melting point range, in comparison with “heterogeneous copolymers”, i.e., polymers having a CDBI of less than 55%. In an embodiment, the homogeneous ethylene/alpha-olefin copolymers exhibit an essentially singular melting point characteristic, with a peak melting point (Tₘ), as determined by Differential Scanning Colorimetry (DSC), of from about 60° C. to 105° C. In an embodiment, the homogeneous copolymer has a DSC peak Tₘ of from about 80° C. to 100° C. As used herein, the phrase “essentially single melting point” means that at least about 80%, by weight, of the material corresponds to a single Tₘ peak at a temperature within the range of from about 60° C. to 105° C., and essentially no substantial fraction of the material has a peak melting point in excess of about 115° C., as determined by DSC analysis. DSC measurements are made on a Perkin Elmer System 7 Thermal Analysis System. Melting information reported are second melting data, i.e., the sample is heated at a programmed rate of 10° C./min to a temperature below its critical range. The sample is then reheated (2nd melting) at a programmed rate of 10° C./min.

A homogeneous ethylene/alpha-olefin copolymer can, in general, be prepared by the copolymerization of ethylene and any one or more alpha-olefin. In certain embodiments, the alpha-olefin is a C₃-C₂₀ alpha-monoolefin, a C₄-C₁₂ alpha-monoolefin, a C₄-C₈ alpha-monoolefin. In an embodiment, the alpha-olefin copolymer comprises at least one member selected from the group consisting of butene-1, hexene-1, and octene-1, i.e., 1-butene, 1-hexene, and 1-octene, respectively. In an embodiment, the alpha-olefin copolymer comprises octene-1, and/or a blend of hexene-1 and butene-1. In another embodiment, the alpha-olefin copolymer comprises a blend of at least two of octene-1, hexene-1 and butene-1.

As used herein, the phrase “ethylene/alpha-olefin copolymer” refers to such heterogeneous materials as linear low density polyethylene (LLDPE), linear medium density polyethylene (LMDPE) and very low and ultra low density polyethylene (VLDPE and ULDPE); and homogeneous polymers such as metallocene catalyzed polymers. These materials generally include copolymers of ethylene with one or more comonomers selected from C4 to C10 alpha-olefins such as butene-1, hexene-1, octane-1, etc. in which the molecules of the copolymers comprise long chains with relatively few side chain branches or cross-linked structures. This molecular structure is to be contrasted with conventional low or medium density polyethylenes which are more highly branched than their respective counterparts. Other ethylene/alpha-olefin copolymers, such as the long chain branched homogeneous ethylene/alpha-olefin copolymers, are another type of ethylene/alpha-olefin copolymer.

“High density polyethylene” (HDPE) as used herein has a density of at least 0.950 grams per cubic centimeter.

“Medium density polyethylene” (MDPE) as used herein has a density in the range of from 0.930 to 0.950 grams per cubic centimeter.

“Low density polyethylene” (LDPE) as used herein has a density in the range of from 0.910 to 0.930 grams per cubic centimeter.

“Linear low density polyethylene” (LLDPE) as used herein has a density in the range of from 0.910 to 0.930 grams per cubic centimeter.

“Very low density polyethylene” VLDPE) as used herein has a density less than 0.915 grams per cubic centimeter.

As used herein, the term “oxygen transmission rate” refers to the oxygen transmitted through a film in accordance with ASTM D3985 “Standard Test Method for Oxygen Gas Transmission Rate Through Plastic Film and Sheeting Using a Coulometric Sensor,” which is hereby incorporated, in its entirety, by reference thereto.

As used herein, the term “density” refers to the density of a solid measured in accordance with ASTM D792 “Standard Test Methods for Density and Specific Gravity (Relative Density) of Plastics by Displacement,” which is hereby incorporated, in its entirety, by reference thereto.

As used herein, the term “melt index” refers to the uniformity of the flow rate of a polymer measured in accordance with ASTM D1238 “Standard Test Method for Melt Flow Rates of Thermoplastics by Extrusion Plastometer,” which is hereby incorporated, in its entirety, by reference thereto.

As used herein, the terms “tensile strength,” elongation at break,” and “Youngs modulus” refer to tensile properties measured in accordance with ASTM D882 “Standard Test Method for Tensile Properties of Thin Plastic Sheeting,” which is hereby incorporated, in its entirety, by reference thereto.

As used herein, the term “tear propagation” refers to the tear propagation resistance of a film measured in accordance with ASTM D1938 “Standard Test Method for Tear-Propagation Resistance (Trouser Tear) of Plastic Film and Thin Sheeting by a Single-Tear Method,” which is hereby incorporated, in its entirety, by reference thereto.

As used herein, the term “impact strength” refers to the puncture properties of a film measured in accordance with ASTM D3763 “Standard Test Method for High Speed Puncture Properties of Plastics Using Load and Displacement Sensors,” which is hereby incorporated, in its entirety, by reference thereto.

As used herein, the term “polyolefin” refers to any polymerized olefin, which can be linear, branched, cyclic, aliphatic, substituted, or unsubstituted. More specifically, included in the term polyolefin are homopolymers of olefin, copolymers of olefin, copolymers of an olefin and an non-olefinic comonomer copolymerizable with the olefin, such as unsaturated ester, unsaturated acid (especially alpha-beta monocarboxylic acids), unsaturated acid anhydride, unsaturated acid metal neutralized salts, and the like. Specific examples include polyethylene homopolymer, polypropylene homopolymer, polybutene, ethylene/alpha-olefin copolymer, propylene/alpha-olefin copolymer, butene/alpha-olefin copolymer, ethylene/vinyl acetate copolymer, ethylene/ethyl acrylate copolymer, ethylene/butyl acrylate copolymer, ethylene/methyl acrylate copolymer, ethylene/acrylic acid copolymer, ethylene/methacrylic acid copolymer, modified polyolefin resin, ionomer resin, polymethylpentene, etc. Modified polyolefin resin is inclusive of modified polymer prepared by copolymerizing the homopolymer of the olefin or copolymer thereof with an unsaturated carboxylic acid, e.g., maleic acid, fumaric acid or the like, or a derivative thereof such as the anhydride, ester or metal salt or the like. It could also be obtained by incorporating into the olefin homopolymer or copolymer, an unsaturated carboxylic acid, e.g., maleic acid, fumaric acid or the like, or a derivative thereof such as the anhydride, ester or metal salt or the like.

As used herein, the phrase “modified polymer,” as well as more specific phrases such as “modified ethylene vinyl acetate copolymer,” and “modified polyolefin” refer to such polymers having an anhydride functionality, as defined immediately above, grafted thereon and/or copolymerized therewith and/or blended therewith. Preferably, such modified polymers have the anhydride functionality grafted on or polymerized therewith, as opposed to merely blended therewith.

In general, the ethylene/alpha-olefin copolymer comprises a copolymer resulting from the copolymerization of from about 80 to 99 weight percent ethylene and from 1 to 20 weight percent alpha-olefin. Preferably, the ethylene alpha-olefin copolymer comprises a copolymer resulting from the copolymerization of from about 85 to 95 weight percent ethylene and from 5 to 15 weight percent alpha-olefin.

The heat seal layer includes a branched ethylene copolymer. The number, size and type of side chains effects the thermo-physical and mechanical properties of a polymer. For example, changing the branching can change the melt index of polymer. An increase in the average branch length results in a larger free volume, reduced packing density, and thus, in a lower glass transition and melting temperature, but increased toughness, and flexibility. Polymers with long side chains have an intrinsic tendency to side-chain crystallization which leads to an increase in the glass transition temperature and melting point.

Branching plays an important role in the performance of polyolefins. For example, linear polyethylene has a high degree of crystallinity and rather poor mechanical properties. Even a small amount of long-chain branches can significantly improve the mechanical properties and the processability of a polyolefin. This is particularly true when the polyolefin has a narrow molecular weight distribution and a high degree of crystallinity. Both the degree of branching as well as the length of the branches affects the density which can vary considerably. Typically, the higher the density of the polymer the higher the degree of crystallinity and the stiffer, harder, and stronger the polymer.

By utilizing single-site metallocene catalysts along with ethylene copolymers with low molecular weight alkenes such as propene, butene-1, hexene-1, 4-methyl-pentene-1 or octene-2, chain branches can be optimized. In general, the toughness and stress crack resistance increases with increasing chain length of the branches. Thus, copolymerization of ethylene with hexene-1 produces tougher polymers than copolymerization with propylene.

Melt flow properties such as melt flow index is also affected by the molecular weight distribution and degree and number of chain branching of the polymer. It has surprisingly been found that by utilizing a branched ethylene copolymer in the heat seal layer, abuse resistance was sufficient without the need for including polyamides in the multilayer film. In particular, the branched ethylene copolymer is a blend from 50 mol % or more ethylene along with 50 mol % or less of a C₆ to C₈ alpha-olefin comonomer. In some embodiments the C₆ to C₈ alpha-olefin comonomer or the branched ethylene copolymer is one or more of 1-hexene and 1-octene

The branched ethylene copolymer further includes at least 0.001 mol % of a remnant of a metal allyl chain transfer agent. The remnant of a metal allyl chain transfer agent is defined to be the portion of the metal allyl chain transfer agent containing an allyl chain end that becomes incorporated into the polymer backbone. In embodiments, the branched ethylene copolymer has from 0.001 to 10 mol % of the remnant of the metal hydrocarbyl chain transfer agent.

Suitable metal allyl chain transfer agent include, but are not limited to chain transfer agent is represented by the Formulas:

M(R′)₃₋ᵥ(R″)ᵥ or E[M(R′)_{2-y}(R″)_{y}]₂
wherein each R′, independently, is a C1 to C30 hydrocarbyl group; each R″, independently, is a C4 to C20, hydrocarbenyl group having an allyl chain end; M is a metal (such as Al); E is a group 16 element (such as O or S); v is from 0.01 to 3 (such as 1 or 2), and y is from 0.01 to 2, such as 1 or 2.

In an embodiment the metal allyl chain transfer agent is an aluminum vinyl-transfer agent (preferably the metal hydrocarbenyl chain represented by the Formula:

M(R′)₃₋ᵥ(R″)ᵥ

With M being Al, R″ defined as a hydrocarbenyl group containing 4 to 20 carbon atoms and featuring an allyl chain end, R′ defined as a hydrocarbyl group containing 1 to 30 carbon atoms, and v is 0.1 to 3 (such as 1 or 2).

Useful aluminum vinyl transfer agents include organo-aluminum compound reaction products between aluminum reagent and an alkyl diene. Suitable alkyl dienes include straight chain or branched alkyl chain and substituted or unsubstituted such as, but not limited to 1,3-butadiene, 1,4-pentadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, 1,14-pentadecadiene, 1,15-hexadecadiene, 1,16-heptadecadiene, 1,17-octadecadiene,1,18-nonadecadiene, 1,19-eicosadiene, 1,20-heneicosadiene, etc. Exemplary aluminum reagents include triisobutylaluminum, diisobutylaluminumhydride, isobutylaluminumdihydride and aluminum hydride.

In embodiments the branched ethylene copolymer has a Mw of 60,000 g/mol or more; 80,000 g/mol or more; or 100,000 g/mol or more. In embodiments the branched ethylene copolymer has a Mw/Mn of less than any of 4.0, 3.5, 3.0 or 2.5.

In embodiments the branched ethylene copolymer has a melt index of less than any of the following values, 1.2, 1.1 or 1.0 g/10 min measured in accordance with ASTM D1238 at 190° C., under a load of 2.16 kg.

### Barrier Layer

As used herein, the term “barrier”, and the phrase “barrier layer”, as applied to films and/or film layers, are used with reference to the ability of a film or film layer to serve as a barrier to one or more gases. Oxygen transmission rate is one method to quantify the effect of a barrier layer. As used herein, the term “oxygen transmission rate” refers to the oxygen transmitted through a film in accordance with ASTM D3985 “Standard Test Method for Oxygen Gas Transmission Rate Through Plastic Film and Sheeting Using a Coulometric Sensor,” which is hereby incorporated, in its entirety, by reference thereto.

The barrier layers include at least 50, 60, 70, 80, 90, or 95% weight of the layer of ethylene-vinyl alcohol copolymer or blends of ethylene-vinyl alcohol copolymers. In an embodiment the barrier layers are substantially all ethylene-vinyl alcohol copolymer. The ethylene content of the ethylene-vinyl alcohol copolymer has an effect on the processability of multilayer films and also has an effect on oxygen transmission rate. Generally, lower ethylene content results in a film that has a lower orientability, and may not be processable at certain orientation ratios. A higher ethylene content generally raises the oxygen transmission rate properties.

In other embodiments, the barrier layers are substantially all ethylene-vinyl alcohol copolymer or blends of ethylene-vinyl alcohol copolymers. Ethylene-vinyl alcohol copolymers may have an ethylene content of about 38 mole %, or at least about any of the following values: 20%, 25%, 30%, 38%, 44% and 48% all mole percent. In embodiments, ethylene-vinyl alcohol copolymers may have an ethylene content of at most about any of the following values: 50%, 48%, 44%, 40%, and 38% all mole percent. In embodiments, the ethylene-vinyl alcohol copolymer or blend of ethylene-vinyl alcohol copolymers resulting in an ethylene content of between 27-48 mol %. Ethylene-vinyl alcohol copolymers may include saponified or hydrolyzed ethylene/vinyl acetate copolymers, such as those having a degree of hydrolysis of at least about any of the following values: 50%, 85%, 95%, 95%. Ethylene-vinyl alcohol copolymers may have an ethylene content ranging from about 20 mole percent to about 50 mole percent. Exemplary ethylene-vinyl alcohol copolymers include those having ethylene contents of 27, 29, 32, 35, 38, 44, 48 and 50 mole % and blends thereof.

A barrier layers may have a thickness of at least about, and/or at most about, any of the following: 0.05, 0.1, 0.15, 0.2, 0.25, 0.5, 1, 2, 3, 4, and 5 mils. In embodiments the barrier layer is less than 15 wt % of the multilayer film. In other embodiments, the barrier layer is less than 10 wt % of the multilayer film. In yet other embodiments, the barrier layer is less than 5 wt % of the multilayer film.

### Tie Layer

The film may comprise one or more intermediate layers, such as a tie layer. In addition to a first intermediate layer, the film may comprise a second intermediate layer. “Intermediate” herein refers to a layer of a multi-layer film which is between an outer layer and an inner layer of the film. “Inner layer” herein refers to a layer which is not an outer or surface layer, and has both of its principal surfaces directly adhered to another layer of the film. “Outer layer” herein refers to any film layer of film having less than two of its principal surfaces directly adhered to another layer of the film. All multilayer films have two, and only two, outer layers, each of which has a principal surface adhered to only one other layer of the multilayer film. In monolayer films, there is only one layer, which, of course, is an outer layer in that neither of its two principal surfaces are adhered to another layer of the film. “Outer layer” also is used with reference to the outermost layer of a plurality of concentrically arranged layers of a seamless tubing, or the outermost layer of a seamed film tubing.

In embodiments with multiple intermediate layers, the composition, thickness, and other characteristics of a second intermediate layer may be substantially the same as any of those of a first intermediate layer, or may differ from any of those of the first intermediate layer.

An intermediate layer may be, for example, between the heat seal layer and the barrier layer. An intermediate layer may be directly adjacent the heat seal layer, so that there is no intervening layer between the intermediate and heat seal layers. An intermediate layer may be directly adjacent the barrier layer, so that there is no intervening layer between the intermediate and barrier layers. An intermediate layer may be directly adjacent both the heat seal layer and the barrier layer.

An intermediate layer may have a thickness of at least about, and/or at most about, any of the following: 0.05, 0.1, 0.15, 0.2, 0.25, 0.5, 1, 2, 3, 4, and 5 mils. The thickness of the intermediate layer as a percentage of the total thickness of the film may be at least about, and/or at most about, any of the following: 1%, 3%, 5%, 7%, 10%, 15%, 20%, and 25%.

An intermediate layer may comprise one or more of any of the tie polymers described herein in at least about, and/or at most about, any of the following amounts: 10%, 20%, 30%, 40%, 50%, 60%, 70%, 75%, 80%, 90%, 95%, and 99.5%, by weight of the layer.

A tie layer refers to an internal film layer that adheres two layers to one another. Useful tie polymers include thermoplastic polymers that may be compatible both with the polymer of one directly adjacent layer and the polymer of the other directly adjacent layer. Such dual compatibility enhances the adhesion of the tied layers to each other. Tie layers can be made from polyolefins such as modified polyolefin, ethylene/vinyl acetate copolymer, modified ethylene/vinyl acetate copolymer, and homogeneous ethylene/alpha-olefin copolymer. Typical tie layer polyolefins include anhydride modified grafted linear low density polyethylene, anhydride grafted (i.e., anhydride modified) low density polyethylene, anhydride grafted very low density polyethylene, anhydride grafted polypropylene, anhydride grafted methyl acrylate copolymer, anhydride grafted butyl acrylate copolymer, homogeneous ethylene/alpha-olefin copolymer, and anhydride grafted ethylene/vinyl acetate copolymer.

As used herein, the term “extrusion” is used with reference to the process of forming continuous shapes by forcing a molten plastic material through a die, followed by cooling or chemical hardening. Immediately prior to extrusion through the die, the relatively high-viscosity polymeric material is fed into a rotating screw of variable pitch, i.e., an extruder, which forces the polymeric material through the die.

As used herein, the term “coextrusion” refers to the process by which the outputs of two or more extruders are brought smoothly together in a feed block, to form a multilayer stream that is fed to a die to produce a layered extrudate. Coextrusion can be employed in film blowing, sheet and flat film extrusion, blow molding, and extrusion coating.

### Substrate Layer

The film may comprise one or more other layers such as a substrate layer. Substrate layers are often a layer or layers of a film that can increase the abuse resistance, toughness, or modulus of a film. In some embodiments the film comprises a substrate layer that functions to increase the abuse resistance, toughness, and/or modulus of the film, substrate layers generally comprise polymers that are inexpensive relative to other polymers in the film that provide some specific purpose unrelated to abuse-resistance, modulus, etc. In an embodiment, the substrate layer comprises at least one member selected from the group consisting of ethylene/alpha-olefin copolymer, ethylene homopolymer, propylene/alpha-olefin copolymer, propylene homopolymer, and combinations thereof. In an embodiment the substrate layer is blend including at least 10 w-t %, 15 wt %, 20 wt %, 25 wt %, 30 wt %, 35 wt %, 40 wt %, 45 wt %, or 50 wt % of a high density polyethylene. In an embodiment the substrate layer blend further includes at least 10 wt %, 15 wt %, 20 wt %, 25 wt %, 30 wt %, 35 wt %, 40 wt %, 45 wt %, or 50 wt % of a linear low density polyethylene, low density polyethylene, very low density polyethylene or blends thereof.

The substrate layer may have a thickness of at least about, and/or at most about, any of the following: 0.05, 0.1, 0.15, 0.2, 0.25, 0.5, 1, 2, 3, 4, and 5 mils. The thickness of the substrate layer as a percentage of the total thickness of the film may be at least about, and/or at most about, any of the following: 1, 3, 5, 7, 10, 15, 20, 25, 30, and 35 percent.

### Multilayer Film

The layers described herein make up a multilayer film. The multilayer film having the desired properties.

As used herein, the phrases “inner layer” and “internal layer” refer to any layer, of a multilayer film, having both of its principal surfaces directly adhered to another layer of the film.

As used herein, the phrase “outer layer” refers to any film layer of film having less than two of its principal surfaces directly adhered to another layer of the film. All multilayer films have two, and only two, outer layers, each of which has a principal surface adhered to only one other layer of the multilayer film. In monolayer films, there is only one layer, which, of course, is an outer layer in that neither of its two principal surfaces are adhered to another layer of the film. “Outer layer” also is used with reference to the outermost layer of a plurality of concentrically arranged layers of a seamless tubing, or the outermost layer of a seamed film tubing.

As used herein, the phrase “directly adhered,” as applied to film layers, is defined as adhesion of the subject film layer to the object film layer, without a tie layer, adhesive, or other layer therebetween. In contrast, as used herein, the word “between,” as applied to a film layer expressed as being between two other specified layers, includes both direct adherence of the subject layer between to the two other layers it is between, as well as including a lack of direct adherence to either or both of the two other layers the subject layer is between, i.e., one or more additional layers can be imposed between the subject layer and one or more of the layers the subject layer is between.

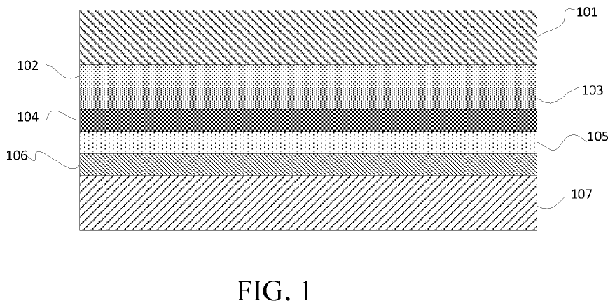

In an embodiment the multilayer film has the structure as shown in FIG. 1. The multilayer film having a first outer layer 101 adhered directly to a substrate layer 102. The barrier layer 104 has tie layer 103 and tie layer 105 directly adhered to either side of the barrier layer 104. Substrate layer 102 being directly adhered to tie layer 103. Substrate layer 106 being directly adhered to tie layer 105 and second outer layer 107. In embodiments at least one of outer layers 101 and 107 are a heat seal layer.

While FIG. 1 is not drawn to scale, in some embodiments the outer layers are the thickest layers of the multilayer film. In embodiments, the outer layers are more than 40%, 45%, 50%, 55% or 60% of the total thickness of the multilayer film. In embodiments, the multilayer film has a thickness of less than any of 400, 300, 200, 150 or 100 μm.

The multilayer film is predominantly polyolefins. In an embodiment, the multilayer film is at least 80 wt % polyolefin. In an embodiment, the multilayer film is at least 85 wt % polyolefin. In an embodiment, the multilayer film is at least 90 wt % polyolefin. In an embodiment, the multilayer film comprises less than 10 wt % of materials other than polyolefin and ethylene-vinyl alcohol copolymers. In an embodiment, the multilayer film comprises less than 5 wt % of materials other than polyolefin and ethylene-vinyl alcohol copolymers.

The multilayer film has a barrier layer of an ethylene-vinyl alcohol copolymer. When ethylene-vinyl alcohol copolymers are used in film structures, the result is normally a more brittle film structure. To overcome this problem in the past, homopolymer polyamides were added the film structure to compensate for this brittleness. However, films utilizing polyamides, such as homopolymer nylons, must be rehydrated and conditioned prior to use. The process taking about 2 to 4 days which slows the process time from formation of the bag to packaging.

The multilayer films described herein are substantially free from polyamides and surprisingly still have good physical properties. The multilayer films have a low oxygen transmission rate and moisture transmission rate while maintaining good abuse resistance and the ability to package blocks of cheese in a physically demanding manner.

The multilayer film exhibits good physical properties for food packaging. In embodiments, the multilayer film has a tensile elongation in either the machine or transverse direction of at least 500%, 600%, 700% or 800% as measured in accordance with ASTM D882 with 25 mm Jaw Separation and 250 mm/min speed. In embodiments, the multilayer film has a dart impact of at least 300, 350, 400 g as measured in accordance with ASTM D1709. The multilayer film has a seal strength of at least 30 N/25 mm as measured in accordance with ASTM F88 when sealed at a temperature of 140-160° C. for 1 second at 52 PSI. The multilayer film has a maximum tear strength in both the machine and transverse directions of at least 5, 6, 7 or 8 N/25 mm measured in accordance with ASTM D1938.

The multilayer film has an oxygen transmission rate of less than any of 50, 40, 30, 20, 10 or 5 cc at standard temperature and pressure (STP)/m2/day/1 atm measured in accordance with ASTM D3985 measured at 23° C., 75% relative humidity and a moisture transmission rate of less than any of 25, 20, 15, 10 or 5 at standard temperature and pressure (STP)/m2/day measured in accordance with ASTM F1249 measured at 38° C. and 90% relative humidity.

As used herein, the phrase “machine direction” refers to a direction along the length of the film, i.e., in the direction of the film as the film is formed during extrusion and/or coating. As used herein, the phrase “transverse direction” refers to a direction across the film, perpendicular to the machine or longitudinal direction.

As used herein, the phrase “free shrink” refers to the percent dimensional change in a 10 cm×10 cm specimen of film, when shrunk at 185° F., with the quantitative determination being carried out according to ASTM D2732 “Standard Test Method for Unrestrained Linear Thermal Shrinkage of Plastic Film and Sheeting.” Unless otherwise indicated, all free shrink values disclosed herein are, of course, “total” free shrink values, which represent a sum of (a) the percent free shrink in the longitudinal (i.e., “machine”) direction dimension and (b) the percent free shrink in transverse direction. The films described herein have a free shrink of less than 10% when shrunk at 185° F., with the quantitative determination being carried out according to ASTM D2732.

As used herein, the term “oriented” refers to a thermoplastic web which forms a film structure in which the web has been elongated in either one direction (“uniaxial”) or two directions (“biaxial”) at elevated temperatures followed by being set in the elongated configuration by cooling the material while substantially retaining the elongated dimensions. This combination of elongation at elevated temperatures followed by cooling causes an alignment of the polymer chains to a more parallel configuration, thereby modifying the mechanical properties of the polymer web. Upon subsequently heating of certain unrestrained, unannealed, oriented sheet of polymer to its orientation temperature, heat shrinkage may be produced.

As used herein, the term “cross-linked” refers to a thermoplastic film having at least 50% gel content. As used herein, the term “gel content” refers to the content of gel material in a thermoplastic film formed because of cross-linking within the polymeric material. Gel content is expressed as a relative percent (by weight) of the polymer which—having formed insoluble carbon-carbon bonds between polymer chains due to cross-linking—is in a gel form. Gel content may be determined by ASTM D2765 “Standard Test Methods for Determination of Gel Content and Swell Ratio of Crosslinked Ethylene Plastics,” which is incorporated herein by reference in its entirety or by the method described in the present experimental section. In embodiments, the multilayer film is not cross-linked.

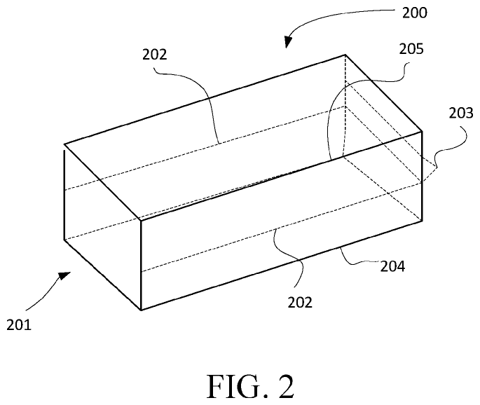

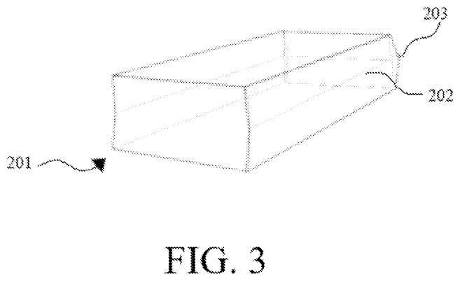

As shown in FIGS. 2-3 the multilayer films described herein can be formed into gusseted pouches or bags. In an embodiment the multilayer film is a tubing and is formed into the gusseted pouch 200 as depicted. In embodiments, the gusted pouch 200 is generally cuboidal shaped. An end seal 203 seals one end of the tubing allowing for a product to be inserted without existing the pouch 200. The pouch 200 having a pair of upper edges 205 and a pair of lower edges 204. Between the upper and lower edges resides fold lines 202 allowing the pouch 200 to have side gussets. This is best depicted in the opening 201 of FIG. 3.

Pouches can be made from tubing or alternatively formed from roll stock. Types of pouches include, but are not limited to, L-seal pouches, side-seal pouches, backseamed pouches and the like. An L-seal pouches has an open top, a bottom seal, one side-seal along a first side edge, and a seamless (i.e., folded, unsealed) second side edge. A side-seal pouches has an open top, a seamless bottom edge, with each of its two side edges having a seal therealong. Although seals along the side and/or bottom edges can be at the very edge itself, (i.e., seals of a type commonly referred to as “trim seals”). A backseamed pouches is a pouches having an open top, a seal running the length of the pouches in which the pouches film is either fin-sealed or lap-sealed, two seamless side edges, and a bottom seal along a bottom edge of the pouches. In embodiments the pouch is made from two films sealed together along the bottom and along each side edge, resulting in a U-seal pattern.

All references to (and incorporations by reference of) ASTM protocols are to the most-recently published ASTM procedure as of the priority (i.e., original) filing date of this patent application in the United States Patent Office.

### EXAMPLES

Table 1 lists the materials used to create the films utilized in the examples.

TABLE 1

| | | Density |
|---|---|---|
| AB | Antiblock - silica in | |
| | Polyethylene, Linear Low | |
| | Density | |
| AO | Antioxidant in LLDPE | |
| EVOH1 | ethylene-vinyl alcohol | 1.21 |
| | copolymer 29% ethylene content | |
| EVOH2 | ethylene-vinyl alcohol | |
| | copolymer 36% ethylene content | |
| HDPE1 | Polyethylene High Density | 0.954 |
| | Homopolymer | |
| HDPE2 | Polyethylene High Density | 0.961 |
| | Homopolymer | |
| LDPE1 | Polyethylene Low Density | 0.923 |
| | Homopolymer - Free Radical | |
| LDPE2 | Polyethylene Low Density | 0.922 |
| | Homopolymer - Free Radical | |
| LLDPE1 | Polyethylene, Linear Low | 0.926 |
| | Density Ethylene/Hexene | |
| | Copolymer - Linear, Single Site | |
| LLDPE2 | Polyethylene, Linear Low | 0.918 |
| | Density Ethylene/Hexene | |
| | Copolymer - Branched, Single | |
| | Site with remnant of a metal | |
| | hydrocarbyl chain transfer agent | |
| LLDPE3 | Polyethylene, Linear Low | 0.92 |
| | Density Ethylene/Hexene | |
| | Copolymer - Linear, Single Site | |
| PA | Processing Aid - Fluoropolymer | |
| | in Polyethylene, Linear Low | |
| | Density - | |
| Slip1 | Slip agent - Siloxane in | |
| | Polyethylene, Low Density | |
| Slip2 | Slip agent - Amide Wax in | |
| | Polyethylene, Low Density | |
| Tie1 | Maleic Anhydride-Modified | |
| | Ethylene/Butene Copolymer | |

Multilayer Films were Coextruded to Form the Following Film Structures:

TABLE 2

| | Layer 1 | Layer 2 | Layer 3 | Layer 4 | Layer 5 | Layer 6 | Layer 7 |
|---|---|---|---|---|---|---|---|
| Film 1 | 85% LLDPE2 | 55% LLDPE1 | 100 wt % | 100% | 100 wt % | 55% LLDPE1 | 85% LLDPE2 |
| | 10% LDPE1 | 45% HDPE1 | Tie1 | EVOH1 | Tie1 | 45% HDPE1 | 10% LDPE1 |
| | 3% Slip1 | | | | | | 3% Slip1 |
| | 1% AB | | | | | | 1% AB |
| | 1% PA | | | | | | 1% PA |
| Thickness (μm) | 29 | 9.5 | 5 | 3.5 | 5 | 9.5 | 28.5 |
| Thickness % | 32.22 | 10.56 | 5.56 | 3.89 | 5.56 | 10.56 | 31.67 |
| Film 2 | LLDPE3 98.8% | 100% LDPE2 | 99% Tie1 | 100% EVOH2 | 99% Tie1 | 98.5% HDPE2 | 97.5% LDPE2 |
| | 1.2% SLIP2 | | 1% AO | | 1% AO | 1% AO | 1% SLIP2 |
| | 1% AB | | | | | 0.5% PA | 1% PA |
| | 1% PA | | | | | | 0.5% AB |
| Thickness (μm) | 24 | 10 | 3 | 5 | 3 | 4 | 26 |
| Thickness % | 32 | 13.33 | 4 | 6.67 | 4 | 5.33 | 34.67 |

Films were tested and also made into side gusted bags to run on a CRYOVAC® CL2O Automatic Cheese Bag Loading System which is a fully automatic loader of Cryovac Gusseted Cheese Bags for 20 kg (40 lb) bulk cheese block farmers. The machine is capable of loading a bag in less than 30 seconds. The Cryovac CL2p is designed to handle pre-made gusseted cheese bags that are packed ready for insertion into a stainless steel magazine. This magazine can be easily loaded with 300±bags at any one time without interruption to cheese production.

The results of the testing procedures are reported in Table 3.

TABLE 3

| | | | Film | | | |
|---|---|---|---|---|---|---|
| | | | Film 1 (W) | | Film 2 (C) | |
| (Width × Thickness): | | | 90 μm | | 90 μm | |
| Transmittance: ASTM D1003 | | | 89.40% | | 89.61% | |
| Haze: ASTM D1003 | | | 29.55% | | 27.85% | |
| Oxygen Transmission Rate (OTR): ASTM | | | 1.78 | | 3.68 | |
| D3985 (cc at standard temperature and pressure | | | | | | |
| (STP)/m2/day/1 atm). Test condition: 23° C., 75% RH | | | | | | |
| Moisture Vapor Transmission Rate (MVTR): | | | 2.94 | | 3.5 | |
| ASTM F1249 (g at standard temperature and | | | | | | |
| pressure (STP)/m2/day/1 atm). Test condition: | | | | | | |
| 38° C., 90% RH | | | | | | |
| Point - Point: | | Average: | 91.0 | μm | 93.0 | μm |
| ASTM D8136 | | Range: | 89 μm-96 μm | | 88 μm-100 μm | |
| Slip (Film): | In - In | COF_{S}: | 0.24 | | 0.25 | |
| ASTM 1894 | | COF_{D} Range: | 0.202-0.229 | | 0.212-0.246 | |
| | Out - Out | COF_{S}: | 0.23 | | 0.25 | |
| | | COF_{D} Range: | 0.198-0.221 | | 0.216-0.235 | |
| | In - Out | COF_{S}: | 0.23 | | 0.25 | |
| | | COF_{D} Range: | 0.201-0.229 | | 0.219-0.242 | |
| Slip (SS): | In - SS | COF_{S}: | 0.17 | | 0.18 | |
| | | COF_{D} Range: | 0.158-0.184 | | 0.162-0.208 | |
| | | COF_{D} Average: | 0.17 | | 0.18 | |
| | Out - SS | COF_{S}: | 0.16 | | 0.17 | |
| | | COF_{D} Range: | 0.150-0.187 | | 0.164-0.205 | |
| | | COF_{D} Average: | 0.17 | | 0.18 | |
| Curl: | In/Sealant | MD | No Curl | | No Curl | |
| | Facing Up | TD | No Curl | | No Curl | |
| | Out/Skin | MD | No Curl | | 1 Degree | |
| | Facing Up | TD | No Curl | | No Curl | |
| FD50 Impact: | | Flat: | >500 | g | >500 | g |
| ASTM D1709 | | Fold | >500 | g | >500 | g |
| Slow Probe: | | Load: | 11.63N | | 16.37N | |
| ASTM F1306 | | Extension: | 10.86 | mm | 10.85 | mm |
| 1% Secant Modulus: | | MD: | 302.1 | MPa | 264.0 | MPa |
| ASTM D882 (25 mm) | | TD: | 301.1 | MPa | 322.0 | MPa |
| Tensile: | MD: | Initial: | 31.3 | | 33.50N | |
| ASTM D882 | | Maximum: | 68.8 | | 79.20N | |
| (N/25 mm) | | Elongation: | 870% | | 515% | |
| 25 mm Jaw | TD: | Initial: | 32.2 | | 38.00N | |
| Separation | | | | | | |
| 250 mm/min | | Maximum: | 67 | | 76.70N | |
| speed | | | | | | |
| | | Elongation: | 883% | | 609% | |
| Tear: | MD: | Initial: | 0.58N | | 0.29N | |
| ASTM D1938 | | Maximum: | 11.04N | | 2.48N | |
| (N/25 mm) | | Extension: | 65.49 | mm | 54.47 | mm |

| | | | |
|---|---|---|---|
| TD: | Initial: | 0.51N | 0.32N |
| | Maximum: | 9.15N | 3.40N |

| | Extension: | 59.92 | mm | 53.42 | mm |
|---|---|---|---|---|---|
| Seal Parameter: | Temperature: | 140° C.-180° C. | | 140-180 | |
| ASTM F88 (25 mm) | Pressure: | 52 | psi | 52 | psi |
| | Time: | 1.0 | s | 1.0 | s |

| | | | |
|---|---|---|---|
| Seal Strength: | Strength: | 35.7N | 46.2N |
| ASTM F88 (N/25 mm) | Mode of Failure: | Snap at Seal | Snap at seal |

As seen from the testing, film 1 showed improved tensile elongation and tear properties when compared to film 2. The film formed a bag suitable for loading of cheese blocks and is a suitable replacement to polyamide-based bags. This reduces times to package product by days as when compared to polyamide-based bags as there is no need to hydrate the bags prior to use.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A multilayer barrier film comprising:
a. a barrier layer comprising at least 95 wt % of an ethylene-vinyl alcohol copolymer, based on the total weight of the barrier layer;
b. a first outer layer comprising at least 95 wt % of a branched ethylene copolymer based on the total weight of the first outer layer, the branched ethylene copolymer comprising 50 mol % or more ethylene, 50 mol % or less of a C₆ to C₈ alpha-olefin comonomer, and at least 0.001 mol % of a remnant of a metal hydrocarbyl chain transfer agent, the branched ethylene copolymer having a density in the range of from 0.910 to 0.930 grams per cubic centimeter;
c. a second outer layer comprising at least 95 wt % linear low density polyethylene, based on the total weight of the second outer layer;
d. a first substrate layer disposed between the barrier layer and the first outer layer; and
e. a second substrate layer disposed between the barrier layer and the second outer layer;
wherein the multilayer film has an oxygen transmission rate of less than 50 cc at standard temperature and pressure (STP)/m²/day/1 atm measured in accordance with ASTM D3985 measured at 23° C., 75% relative humidity and a moisture transmission rate of less than 25 g at standard temperature and pressure (STP)/m²/day measured in accordance with ASTM F1249 measured at 38° C. and 90% relative humidity.

2. The multilayer film of claim 1 further comprising a first tie layer directly adhered to the first substrate layer and the barrier layer and a second tie layer directly adhered to the second substrate layer and the barrier layer.

3. The multilayer film of claim 1 wherein branched ethylene copolymer has a melt index of less than 1.2 g/10 min measured in accordance with ASTM D1238 at 190° C., under a load of 2.16 kg.

4. The multilayer film of claim 1 wherein branched ethylene copolymer has from 0.001 to 10 mol % of the remnant of the metal hydrocarbyl chain transfer agent.

5. The multilayer film of claim 1 wherein the C₆ to C₈ alpha-olefin comonomer or the branched ethylene copolymer is one or more of 1-hexene and 1-octene.

6. The multilayer film of claim 1 wherein the first and second outer layers make up at least 50% of the total thickness of the multilayer film.

7. The multilayer film of claim 1 wherein the barrier layer makes up less than 5% of the total thickness of the multilayer film.

8. The multilayer film of claim 1 wherein the multilayer film comprises at least 90 wt % polyolefin based on the total weight of the multilayer film.

9. The multilayer film of claim 1 wherein the multilayer film comprises less than 5 wt % of materials other than polyolefin and ethylene-vinyl alcohol copolymers.

10. (canceled)

11. The multilayer film of claim 1 wherein the multilayer film has a tensile elongation in either the machine or transverse direction of at least 500% as measured in accordance with ASTM D882 with 25 mm Jaw Separation and 250 mm/min speed.

12. The multilayer film of claim 1 wherein the multilayer film has a dart impact of at least 300 as measured in accordance with ASTM D1709.

13. The multilayer film of claim 1 wherein the multilayer film has a seal strength of at least 30 N/25 mm as measured in accordance with ASTM F88 when sealed at a temperature of 140-160° C. for 1 second at 52 PSI.

14. The multilayer film of claim 1 wherein the multilayer film has a maximum tear strength in both the machine and transverse directions of at least N/25 mm measured in accordance with ASTM D1938.

15. (canceled)

16. The multilayer film of claim 1 wherein the branched ethylene copolymer is a linear low density polyethylene.

17. The multilayer film of claim 1 wherein the branched ethylene copolymer has a Mw of 60,000 g/mol or more; and has a Mw/Mn of less than 3.0.

18. The multilayer film of claim 1 wherein the metal hydrocarbyl chain transfer agent is represented by the formula:
M(R′)₃₋ᵥ(R″)ᵥ or E[M(R′)_{2-y}(R″)_{y}]₂
wherein each R′, independently, is a C1 to C30 hydrocarbyl group; each R″, independently, is a C4 to C20, hydrocarbenyl group having an allyl chain end; M is a metal; E is a group 16 element; v is from 0.01 to 3; and y is from 0.01 to 2.

19. The multilayer film of claim 1 wherein the multilayer film is not cross linked.

20. The multilayer film of claim 1 wherein the multilayer film is formed into a gusseted pouch.

21. A gusseted pouch made from a multilayer film, the pouch comprising at least one seam and at least two fold lines to create a pair of side gussets in the pouch, the pouch being in a generally cuboidal shape, the multilayer film comprising:
a. a barrier layer comprising at least 95 wt % of an ethylene-vinyl alcohol copolymer, based on the total weight of the barrier layer;
b. a first outer layer comprising at least 95 wt % of a branched ethylene copolymer based on the total weight of the first outer layer, the branched ethylene copolymer comprising 50 mol % or more ethylene, 50 mol % or less of a C₆ to C₈ alpha-olefin comonomer, and at least 0.001 mol % of a remnant of a metal hydrocarbyl chain transfer agent, the branched ethylene copolymer having a density in the range of from 0.910 to 0.930 grams per cubic centimeter;
c. a second outer layer comprising at least 95 wt % linear low density polyethylene, based on the total weight of the second outer layer;
d. a first substrate layer disposed between the barrier layer and the first outer layer; and
e. a second substrate layer disposed between the barrier layer and the second outer layer;
wherein the multilayer film has an oxygen transmission rate of less than 50 cc at standard temperature and pressure (STP)/m²/day/1 atm measured in accordance with ASTM D3985 measured at 23° C., 75% relative humidity and a moisture transmission rate of less than 25 g at standard temperature and pressure (STP)/m²/day measured in accordance with ASTM F1249 measured at 38° C. and 90% relative humidity.

22. (canceled)

23. (canceled)

24. (canceled)

25. (canceled)

26. (canceled)

27. (canceled)

28. (canceled)

29. (canceled)

30. (canceled)

31. A method for bagging a food product comprising the steps of:
a. providing a gusseted pouch;
b. filing the pouch with a solid food product; and
c. sealing the pouch;
wherein the pouch made from a multilayer film, comprising:
i. a barrier layer comprising at least 95 wt % of an ethylene-vinyl alcohol copolymer, based on the total weight of the barrier layer;
ii. a first outer layer comprising at least 95 wt % of a branched ethylene copolymer based on the total weight of the first outer layer, the branched ethylene copolymer comprising 50 mol % or more ethylene, 50 mol % or less of a C₆ to C₈ alpha-olefin comonomer, and at least 0.001 mol % of a remnant of a metal hydrocarbyl chain transfer agent, the branched ethylene copolymer having a density in the range of from 0.910 to 0.930 grams per cubic centimeter,
iii. a second outer layer comprising at least 95 wt % linear low density polyethylene, based on the total weight of the second outer layer
iv. a first substrate layer disposed between the barrier layer and the first outer layer; and
v. a second substrate layer disposed between the barrier layer and the second outer layer
wherein the multilayer film has an oxygen transmission rate of less than 50 cc at standard temperature and pressure (STP)/m²/day/1 atm measured in accordance with ASTM D3985 measured at 23° C., 75% relative humidity and a moisture transmission rate of less than 25 g at standard temperature and pressure (STP)/m²/day measured in accordance with ASTM F1249 measured at 38° C. and 90% relative humidity.

32. (canceled)
